(19) United States
(12) Patent Application Publication
(10) Pub. No.: US 2023/0191662 A1
(43) Pub. Date: Jun. 22, 2023

(54) Method For Producing An Arc-Shaped Fibre Composite Component, And Preform

(71) Applicant: Premium Aerotec GmbH, (US)

(72) Inventors: Chris Rennecke, Augsburg (DE); Christian Gensewich, Augsburg (DE)

(73) Assignee: Premium Aerotec GmbH, Augsburg (DE)

(21) Appl. No.: 17/923,410

(22) PCT Filed: May 4, 2021
(86) PCT No.: PCT/EP2021/061623

§ 371 Date: Nov. 4, 2022

(30) Foreign Application Priority Data
May 7, 2020 (DE) 10 2020 205 790.7

(51) Int. Cl. B29B 11/16; B29C 70/38; B64F 5/10

(52) U.S. Cl. CPC B29B 11/16; B29C 70/386; B64F 5/10; B29L 2031/3076

(57) ABSTRACT

A method of manufacturing an arc-shaped fiber composite component includes forming a preform with a planar fiber layer arrangement formed along an arc and having an outer edge assigned to a convex outer side of the arc. The outer edge is formed with gaps extending into the arrangement in such a manner that a contour of the gaps is formed at least in sections near a target contour of a respective recess to be provided in the component. The preform is formed such that a first region of the arrangement, adjacent to the outer edge and extending substantially in the direction of the arc, is bent or angled relative to a second region of the arrangement, adjacent to the first region remote from the outer side of the arc. The gaps that the preform has prior to reshaping merge into recesses of the formed preform and remain open.

The invention relates to the manufacture of fiber composite components, in particular to the manufacture of an arc-shaped fiber composite component, and to a preform for the manufacture of such a fiber composite component.

The production of curved profiles from fiber composite plastic is described, for example, in DE 10 2016 109 284 B3. According to the procedure proposed in DE 10 2016 109 284 B3, the curved profile is manufactured using an arc-shaped preform. An inner region of the preform has a corrugated relief structure formed along the course of the arc, whereas an outer region of the preform has radially aligned, wedge-shaped recesses. The outer area is pressed against a cheek surface of a forming tool as an upsetting area, with the wedge-shaped recesses closing.

With the conventional approach, additional work steps are required in the manufacturing process to incorporate the wedge-shaped recesses into the planar preform in preparation for the forming. This can also result in costs due to waste and material losses. To achieve the final contour of the workpiece, additional geometric features may have to be worked into the workpiece in a further operation, e.g. by milling, with additional offcuts or milling waste.

It would therefore be desirable to reduce material consumption and waste compared with this conventional approach and, in addition, to further reduce the number of work steps in order to make it possible to manufacture the fiber composite component more efficiently and with less effort and waste.

Against this background, the invention is based on the task of specifying an improved process which makes it possible to manufacture an arc-shaped fiber composite component more efficiently, in particular with at least partial automation, and in doing so additionally to save material and processing steps and to better avoid waste.

According to the invention, this task is solved by a method having the features of claim 1 and/or by a preform having the features of claim 15.

Accordingly, a method for manufacturing an arc-shaped fiber composite component is proposed, which comprises:
Forming of a preform with a planar fiber layer arrangement formed along an arc and having an outer edge assigned to a convex outer side of the arc, the outer edge being formed with gaps extending into the planar fiber layer arrangement in such a way that a contour of the gaps is formed in each case at least in sections close to a target contour of a recess to be provided in the fiber composite component in each case. In this case, the contour of the gaps can be formed in each case, in particular at least in sections, close to the target contour except for a projection which, after further processing of the preform in a later step, allows material-removing processing for precisely achieving the target contour. And:
Reshaping the preform in such a way that at least a first region of the planar fiber layer arrangement, which adjoins the outer edge and extends substantially in the direction of the arc, is bent or angled relative to a second region of the planar fiber layer arrangement, which adjoins the first region remote from the outer side of the arc. In this regard, when the formed preform is formed, the gaps formed in the preform prior to reshaping merge into recesses in the formed preform and remain open.

Furthermore, a preform is provided for manufacturing an arc-shaped fiber composite component by such a process with forming of the preform. The preform has planar fiber layer arrangement formed along an arc and having an outer edge assigned to a convex outer side of the arc. The outer edge is formed with gaps extending into the planar fiber layer arrangement. In this case, a contour of the gaps is formed in each case at least in sections close to a target contour of a recess to be provided in each case in the fiber composite component to be produced, in particular at least in sections as far as a projection which, after further processing of the preform in a later step, allows material-removing processing to achieve the target contour exactly.

According to another aspect, a further method is proposed for producing a fiber composite component, in particular of an arc-shaped design, which comprises forming a preform with a planar fiber layer arrangement formed in particular along an arc, reshaping the previously formed preform, and further processing the reshaped preform. In the further method, it is provided that the forming and/or reshaping of the preform and/or the further processing thereof, in particular a further processing by curing of a matrix material, are carried out in such a way that the, in particular cured, workpiece emerging from the reshaped preform, has a geometry before a material-removing thereof which deviates specifically from the target geometry of the fiber composite component in such a way that the geometry of the workpiece after the material-removing processing, in particular with release of residual stresses in the workpiece, essentially corresponds to the target geometry.

According to yet another aspect, a still further process is proposed for producing a fiber composite component, in particular of an arc-shaped design, which comprises forming a preform with a planar fiber layer arrangement, formed in particular along an arc, reshaping the previously formed preform, and further processing the reshaped preform, in particular further processing by curing a matrix material. In this case, the forming of the preform takes place on a layup surface of a laying tool, the reshaping takes place by a reshaping tool, and the further processing of the , in particular cured, reshaped preform takes place by a further processing tool, in particular a curing tool, wherein a shaping of the layup surface and/or of a base surface of the layup surface and/or of the reshaping tool and/or of the further processing tool, preferably in combination the shape of the layup surface and its base surface and of the forming tool and of the further processing tool, are deviating specifically from the target geometry of the fiber composite component in order to take account of shape deviations during the further processing, for example due to shrinkage, and shape deviations during the material-removing processing, for example due to the release of internal stresses, in such a way that the finished fiber composite component essentially corresponds to the target geometry. In particular, the forming tool can be provided separately from the further processing tool or alternatively be used or co-used during further processing, for example in the curing step.

One idea underlying the invention is to enable length compensation in the arc direction in the first area during forming of the preform with the aid of the gaps, whereby the gaps are already provided close to the target contour in the preform which has not yet been formed. In this way, precursors for geometric features required in the final geometry of the finished fiber composite component can be used in the form of the gaps for surface compensation during forming on the convex outer side of the arc, which undergoes overall a compression during forming. Additional cuts or the like, which cause additional work and waste, are avoided. At the same time, the amount of post-processing required to produce the exact target contour of the recesses is reduced, since less material has to be removed, again producing little waste. The additional material consumption due to manufacturing is thus advantageously reduced in the invention, as are offcuts and waste. The invention contributes to an efficient, automatable and economical production of the preform.

Further ideas according to the further aspects include compensating for expected shape deviations of the fiber composite component in the manufacturing process already during one or more steps of the manufacturing process, in order to achieve the target geometry in the finished fiber composite component as accurately and efficiently as possible.

Advantageous embodiments and further developments result from the further subclaims as well as from the description with reference to the figures.

In one embodiment, the gaps extend through the first region of the planar fiber layer arrangement and further extend in sections into the second region of the planar fiber layer arrangement. This can be advantageous in order to take geometric features of the finished fiber composite component into account to a large extent already in the preform and thus to reduce the amount of post-processing work and waste. The gaps can thus already largely take into account the required final size of the recesses.

In one further embodiment, the gaps are arranged along the arc at irregular intervals, at least in some areas. In this way, the gaps can already be provided in the not yet formed preform according to the specification and intended use of the finished fiber composite component. Alternatively or in combination therewith, however, an arrangement of the gaps along the arc at regular or at least regionally regular intervals is also possible. Sections with regular and irregular arrangement of the gaps can be combined.

In particular, in one embodiment, the contour of substantially the entire outer edge of the fibrous layer assembly may be formed close to the target contour.

According to one embodiment, the gap in the fiber composite component has a rounded base in accordance with the target contour thereof. In particular, the gaps of the preform can each have, in the region of the base thereof, an at least approximately rounded-out boundary which approximates the target contour of the recess in the region of the rounded-out base thereof. A rounded-out base can be mechanically advantageous, for example, and help to avoid mechanical stress peaks.

In one embodiment, the outer edge is additionally formed with at least one rear offset extending into the planar fiber layer arrangement and ending before reaching the second region. In this way, the preform can further take into account the target geometry of the fiber composite component, for example also to further reduce the component weight. However, in other, equally useful and advantageous embodiments of the invention, such additional rear offset(s) may be omitted.

In a further embodiment, in forming the preform, the fibrous layer array is formed on a layup surface, the layup surface having an area with a succession of depressions and/or elevations in succession in the direction of the arc relative to a base area of the layup surface. In this case, the planar fiber layer arrangement is formed with an inner edge assigned to a concave inner side of the arc, and a third region of the planar fiber layer arrangement, which extends adjacent to the inner edge substantially in the direction of the arc, is formed at least partially on the region of the layup surface provided with the depressions and/or elevations. In this way, the change in length in the third area can be maintained when the third area is angled or bent relative to the second area during the forming of the preform with the aid of the depressions and/or elevations which, when the fiber layer arrangement is formed, cause a corresponding spatial structure thereof in the third area. The formation of the fiber layer arrangement in this way thus makes it possible to provide the additional surface area required in the formed preform in the third region, so that problem-free forming becomes possible.

According to one embodiment, the first region and the second region of the planar fiber layer arrangement of the preform are formed prior to reshaping thereof on a substantially planar or only slightly curved surface part, in particular on a substantially planar or only slightly curved part of the layup surface in comparison with the region of the layup surface provided with the depressions and/or elevations. In the first region, which adjoins the outer edge, the excess material then existing in this region can be compensated for by the gaps in view of the convexity of the outer side when the preform is formed from a substantially planar initial shape. The gaps can here be formed in the first region, and if they extend into the second region, also in the second region, in an effective and efficient manner close to the target contour.

In a further development, the layup surface with the depressions and/or elevations is formed with a wave-like shape when viewed in a section parallel to the direction of the arc. For example, the wave-like shape can be a sinusoidal shape when viewed in at least one sectional plane. However, other waveforms deviating from a sinusoidal shape are also conceivable.

In particular, the fiber composite component is elongated. Such a component can advantageously be used, for example, to stiffen other components, such as a skin component.

In a preferred embodiment, the fiber composite component is formed in a profiled shape with an outer flange and a web connected to the outer flange, wherein the outer flange is formed with the first region of the planar fiber layer assembly and the web is formed with the second region of the planar fiber layer assembly.

In particular, in a further embodiment, the fiber composite component may be formed in a profile shape with an outer flange, an inner flange, and a web connected to the outer flange and the inner flange between the outer flange and the inner flange. Here, the outer flange is formed with the first portion of the planar fiber layer assembly, the web is formed with the second portion of the planar fiber layer assembly, and the inner flange is formed with the third portion of the planar fiber layer assembly.

In particular, the profile shape of the fiber composite component can be formed as a C-profile in its cross-section.

In further embodiments, the height of the web, i.e. its dimension between the outer and inner flanges, can be constant or vary along the curve. For example, the height of the web as seen along the curve can be made smaller in the center of the fiber composite component than at the ends of the fiber composite component. In this way, for example, different requirements in terms of weight and space requirements of the fiber composite component on the one hand and the ability of the fiber composite component to absorb loads on the other hand can be met in a further improved manner.

In further embodiments, the preform, both before and after forming, can have locally different thicknesses. In this way, for example, it can be made possible in a further improved manner to save weight and at the same time meet the loads that the fiber composite component is intended to carry. Different local thicknesses can be achieved, for example, by locally providing a different number of fiber layers in the fiber layer arrangement. For example, fewer fiber layers can be provided at front ends of the preform and the preform can thus be made thinner than in a central region of the preform, where the preform can be made with more fiber layers and thus thicker.

In a preferred further development, the planar fiber layer arrangement is formed by, in particular, automated depositing of fiber material, in particular of fiber tapes. In this way, the arrangement, course and orientation of the reinforcing fibers can be specifically influenced, for example in order to meet the requirements placed on the fiber composite component, for example in terms of strength, stiffness, weight, etc. Automation of the laying process can contribute to an efficient and cost-saving manufacturing process.

The automated depositing of the fiber tapes, for example, can be carried out by an automated, for example computer-controlled, depositing device. The depositing device can, for example, be a depositing robot.

In particular, when the fiber tapes are deposited, the gaps of the preform are taken into account in such a way that only a small amount of waste is produced during subsequent material-removing processing to achieve the target contour. In particular, the fiber tapes can be deposited in such a way that the edges of the deposited fiber layers formed by the fiber tapes each approximate a contour which runs close to the target contour of the fiber composite component, in particular in the region of the gaps thereof.

Furthermore, in the third area of the planar fiber layer arrangement, the fiber tapes are deposited in particular at least partially on the area of the layup surface provided with the depressions and/or elevations. This is a simple and effective way of providing additional surface area of the fiber layer arrangement for the reshaping in the third area.

In a further embodiment, the fiber layer assembly is formed with reinforcing fibers that are pre-impregnated with a matrix material. In particular, the fiber tapes may have reinforcing fibers pre-impregnated with the matrix material. Pre-impregnation of the fibers as pre-preg may further contribute to efficient fabrication of the fiber composite component.

In one embodiment, the fiber composite component may be formed with a plastic matrix comprising a thermosetting plastic material. In this case, the matrix material preferably comprises a plastic material, such as a synthetic resin, which can be cured under the action of heat.

Alternatively, in another embodiment, the fiber composite component may be formed with a thermoplastic resin material. In this case, the matrix material comprises a thermoplastic material.

In case of both the thermoplastic and thermosetting matrix material, the reinforcing fibers are preferably pre-impregnated with the matrix material, as described above.

In further embodiments, the fiber layer arrangement may have fiber layers with different fiber orientations. In particular, the fiber layers may comprise 0-degree layers with a fiber orientation following the arc direction and/or layers with a fiber orientation extending at an angle to the arc direction, for example 30-degree layers and/or 45-degree layers and/or 90-degree layers. Other angles between fiber and arc directions other than 0, 30, 45 or 90 degrees are conceivable and may be equally useful and advantageous. In particular, any selection of fiber orientations and combinations thereof in the preform is possible, depending on the requirements of the fiber composite component.

In further embodiments, different fiber types are conceivable for forming the fiber layer arrangement. For example, the fiber layer arrangement may comprise carbon fibers or glass fibers or a combination thereof as reinforcing fibers. Other fiber types may also be considered.

In particular, in one embodiment, the fiber composite component is formed as a structural component for an aircraft or spacecraft, for example for an airplane. Fiber composite components as structural components can be of great benefit in the field of aerospace in that reduced component weight can be combined with mechanical component properties that are particularly well adapted to the expected loads. The invention can help to produce such advantageous components in a more efficient and economical manner.

In a further embodiment, the fiber composite component may be formed as a frame or a section of a frame for an aircraft or spacecraft. In particular, the fiber composite component is formed, for example, as a frame for the fuselage shell of the aircraft or spacecraft, such as an airplane, or as a section of such a frame. For frames as structural components with often relatively complex, overall curved or bent geometry, the invention can advantageously contribute to a significant improvement of the manufacturing process in terms of efficiency, economy and waste prevention.

In further embodiments, the fiber composite component may be formed as an upper shell frame or as a side shell frame or as a section of an upper shell or side shell frame. In this case, the upper shell frame or side shell frame reinforces, for example, an upper shell or a side shell of a fuselage segment of the aircraft or spacecraft, for example aircraft.

In a preferred embodiment, the fiber composite component is formed as an integral frame. Integral frames help to avoid the individual manufacture of a large number of frame components and their assembly and fastening to one another, and in this way can help to reduce labor and weight. The aforementioned advantages of the invention are particularly useful to a further enhanced degree in case of integrally formed frames which are to be manufactured as complex components in one piece.

In a further development, at least one of the gaps or several or all of the gaps in the fiber composite component is provided in each case as a passageway for the passage of at least one stringer. Thus, on the one hand, a plurality of such required gaps, for example, in case of the aforementioned frames can be efficiently provided. On the other hand, with the aid of the gaps then provided in multiplicity in the preform as precursors for the recesses, effective surface compensation is possible in the first region in an advantageous manner.

In particular, at least one of the gaps or several or all of the gaps in the fiber composite component can be formed with a mousehole-like shape.

In one embodiment, the forming of the preform is performed as hot forming under the action of heat.

In one embodiment, the thermosetting matrix material is cured after the preform has been formed, for example using heat, in particular under the additional action of elevated pressure, for example in an autoclave. The curing can take place in a curing tool designed for this purpose.

In further embodiments, the workpiece is demolded after curing and subsequently machined to remove material, in particular by milling, in order to achieve the target contour. The workpiece can be trimmed, in particular in areas corresponding to the gaps of the preform, in order to achieve the target contour of the recesses. This helps to achieve the target geometry accurately. In particular, it can be provided that the entire edge area of the cured workpiece is machined for trimming.

In embodiments, after the material-removing processing, further process steps may be provided which comprise checking the dimensional accuracy and/or the freedom from defects of the fiber composite component and/or sealing edges of the fiber composite component and/or a final quality control.

In a further embodiment, the forming and/or reshaping of the preform and/or its further processing, in particular further processing by curing the matrix material, can be carried out in such a way that the workpiece emerging from the reshaped preform, in particular cured, has a geometry prior to material-removing processing thereof which deviates specifically from the target geometry of the fiber composite component in such a way that the geometry of the workpiece after material-removing processing, in particular with release of residual stresses in the workpiece, essentially corresponds to the target geometry. Deviations in the shape of the finished fiber composite component from the desired target geometry can be reduced even further by retaining deformations of this kind, for example the so-called “spring-in” behavior of the workpiece and possibly other deformations. Such deviations from the desired target geometry, which occur in the finished component without this being maintained during the manufacturing process, and here in particular during the formation of the preform and/or its forming and/or its further processing by curing, can be due to the aforementioned release of residual stresses during mechanical, material-removing processing and additionally to shrinkage of the matrix material during further processing, for example resin shrinkage during curing and crosslinking of the matrix material.

In particular, in a further embodiment, the preform can be formed on a layup surface, the preform can be formed by a forming tool, and the formed preform can be further processed, in particular cured, by a further processing tool, in particular a curing tool, wherein a shaping of the layup surface and/or its base surface and/or of the forming tool and/or of the further processing tool, preferably in combination, the shaping of the lay-up surface and its base surface and of the forming tool and the further processing tool, deviating specifically from the target geometry of the fiber composite component in order to take into account shape deviations during further processing, for example due to shrinkage, and shape deviations during material-removing processing, for example due to the release of residual stresses, in such a way that the finished fiber composite component essentially corresponds to the target geometry.

The above embodiments and further embodiments can be combined with each other as desired, if useful. Further possible embodiments, further developments and implementations of the invention also include combinations, not explicitly mentioned, of features of the invention described before or below with respect to the embodiments. In particular, the skilled person will thereby also add individual aspects as improvements or additions to the respective basic form of the present invention.

In particular, all of the embodiments, further embodiments and further developments explained above are applicable in an analogous manner to the processes, to the preform and to the fiber composite components produced by the processes, in particular using the preform.

The invention is explained in more detail below with reference to the embodiments given in the schematic figures. It is shown in:

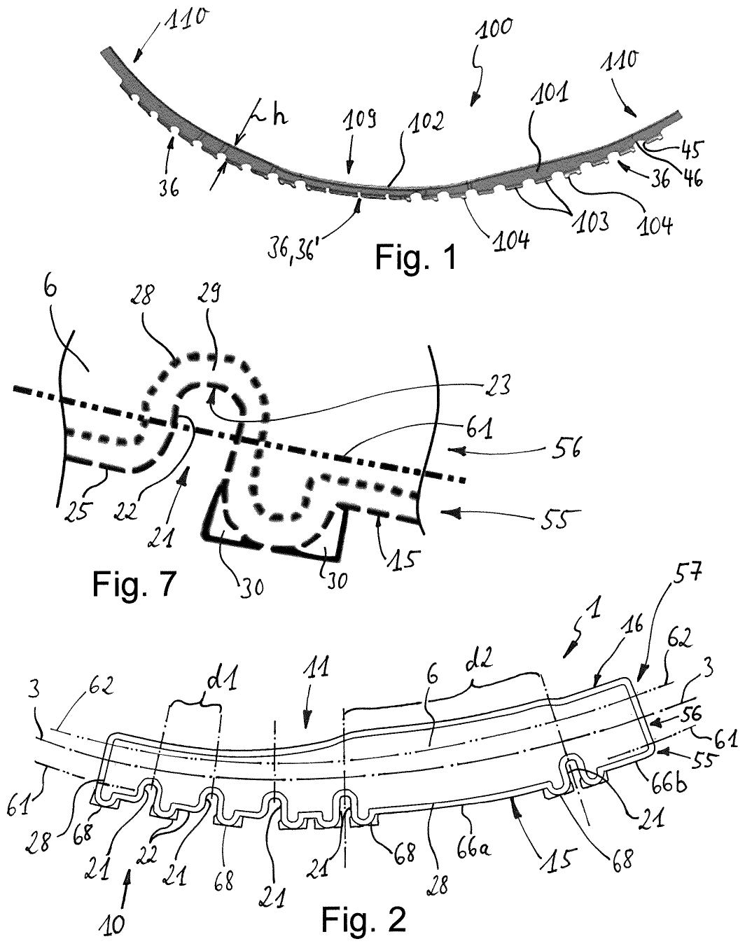

FIG. 1 in a perspective view, an exemplary integral frame formed with a fiber-reinforced plastic material, exemplarily formed as a side shell frame for a fuselage shell of an aircraft or spacecraft;

FIG. 2 a preform according to an embodiment example, before forming the preform, wherein a fiber layer with a 0 degree orientation of reinforcing fibers is shown in a top view;

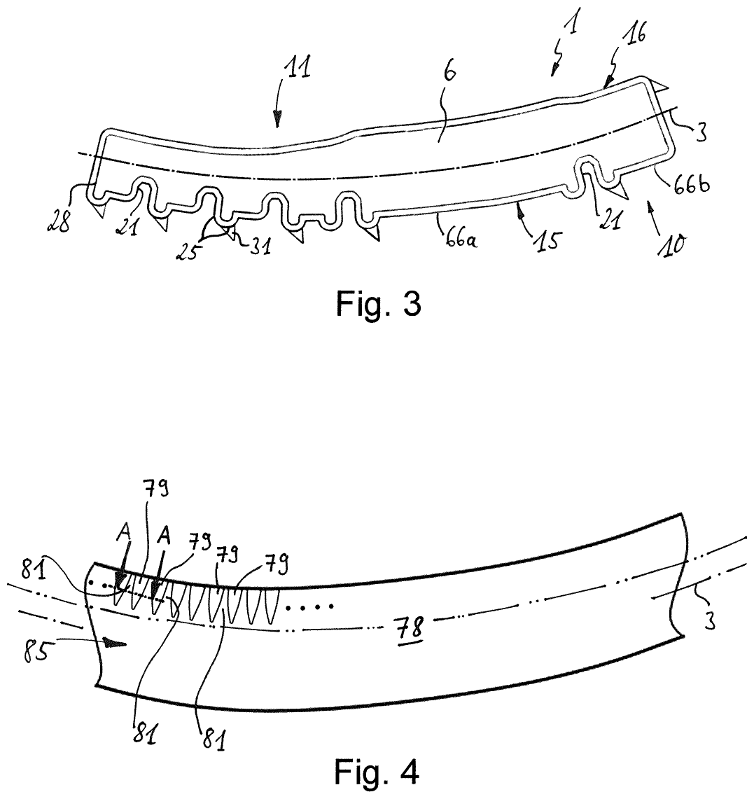

FIG. 3 the preform of FIG. 2 before reshaping the preform, with a further fiber layer with a 45-degree orientation of reinforcing fibers shown in a plan view;

FIG. 4 a lay-up surface for forming the preform according to the exemplary embodiment of FIGS. 2 and 3, schematically in a top view;

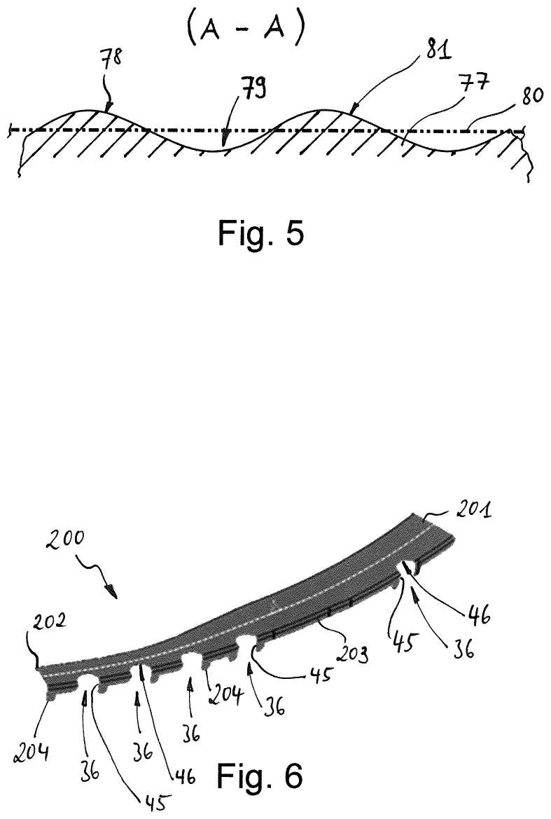

FIG. 5 a section along line A-A, as shown in FIG. 4, to illustrate the surface shape of the layup surface;

FIG. 6 a fiber composite component obtained as a workpiece after forming the preform according to the exemplary embodiment of FIGS. 2 and 3 and after curing and finishing;

FIG. 7 a detail from FIG. 2 in the vicinity of a gap of the preform shown furthest to the left in FIG. 2;

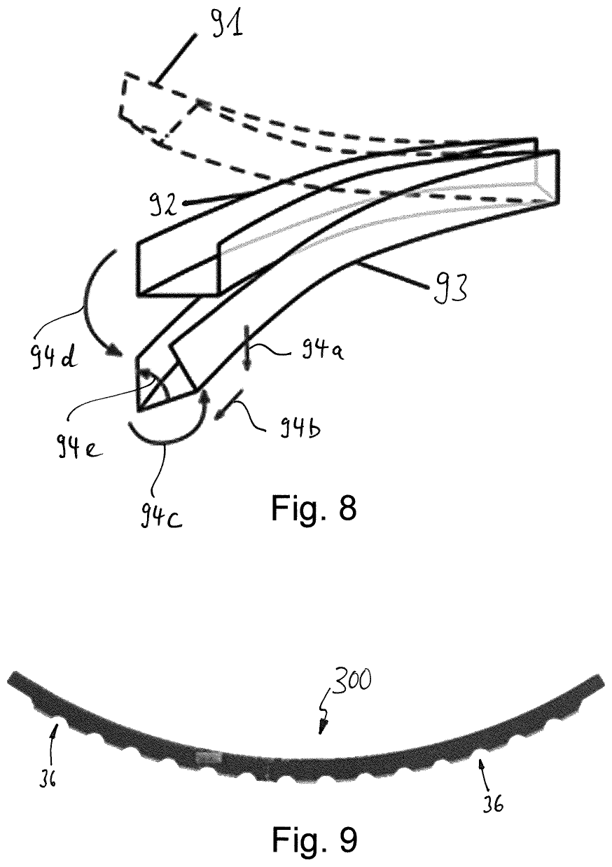

FIG. 8 a schematic illustration to illustrate the deformation behavior of the workpiece due to residual stresses and resin shrinkage and how this deformation behavior is taken into account, in a variant of the embodiment; and

FIG. 9 a side view of a further exemplary integral frame formed with a fiber-reinforced plastic material, exemplarily designed as a top shell frame for a fuselage shell of an aircraft or spacecraft.

The accompanying figures are intended to provide a further understanding of embodiments of the invention. They illustrate embodiments and, in connection with the description, serve to explain principles and concepts of the invention. Other embodiments and many of the advantages mentioned will be apparent with reference to the drawings. The elements of the drawings are not necessarily shown to scale with respect to each other.

In the figures of the drawings, identical elements, features and components with the same function and the same effect—unless otherwise stated—are each provided with the same reference signs.

FIG. 1 shows an example of an integral frame 100 for a fuselage shell of an aircraft or spacecraft, for example an airplane, wherein the integral frame 100 of FIG. 1 is designed as a side shell frame and is thus intended for use in a fuselage shell designed as a side shell. The integral frame 100 is formed as a structural fiber composite component of the aircraft or spacecraft and is made, for example, of carbon fiber reinforced plastic material (CFRP).

The integral frame 100 of FIG. 1 is profile-shaped and has an elongated, arcuate shape. The cross-sectional shape of the integral frame 100 of FIG. 1 is substantially C-shaped, with the frame 100 having a web 101, an inner flange 102 and an outer flange 103. With respect to an arc, not specified in FIG. 1, which the frame 100 follows, the outer flange 103 is assigned to a convex outer side of the arc and the inner flange 102 is assigned to a concave inner side of the arc. The inner flange 102 and the outer flange 103 are each integrally connected to the web 101, which is disposed between the flanges 102 and 103.

The integral frame 100 has a plurality of recesses 36 extending through the outer flange 103 and into the web 101. The recesses 36, or a plurality thereof, may be provided, for example, to allow additional stiffening elements, particularly stringers, disposed on the inside of a shell skin of the fuselage shell for additional stiffening, to pass through the recesses 36 in a fuselage shell of the aircraft or spacecraft. A plurality of the recesses 36 are each shaped like mouse holes in the frame 100 of FIG. 1, and thus may be referred to as “mouse holes” or, by the English language term “mouseholes”. Some of the recesses 36 in the center region 109 of the integral frame, additionally designated 36′ in FIG. 1, are smaller in shape but also extend into the web 101. The plurality of recesses 36, 36′ divide the outer flange 103 into a number of sections.

A height h of the web 101 is not constant in FIG. 1, but varies along the course of the arc. Here, his lower in the center 109 of the integral frame 100 than at its front ends 110. Alternatively, a constant height h would be conceivable.

FIG. 9 shows another exemplary integral frame 300 as an upper shell frame for a fuselage shell of an aircraft or spacecraft, in particular an airplane. The integral frame 300 is also designed as a structural fiber composite component of the aircraft or spacecraft and is made, for example, of carbon fiber-reinforced plastic material. Also the frame 300 of FIG. 9 has a plurality of recesses 36. The above explanations for the frame 100 are analogously applicable to the frame 300, with the exception of differences still described below and with the exception that in the frame 300 the height h of the web is substantially constant and the smaller recesses 36′ are absent.

A method according to an embodiment example for manufacturing, for example, a frame 100 analogous to that of FIG. 1 or a frame 300 analogous to that of FIG. 9 is explained below with reference to FIGS. 2-7. Here, FIGS. 2, 3 and 7 show a fiber composite plastic preform 1, while FIG. 6 shows a fiber composite component 200 as a workpiece obtained starting from the preform 1 according to the specific example of FIGS. 2, 3, 7. The preform 1 and the workpiece 200 may correspond, for example, to a section of an integral frame analogous to the frame 100 of FIG. 1, but in a variant could instead be formed, for example, to correspond to a section of an integral frame analogous to frame 300 of FIG. 9. In this regard, it is understood that the detailed design of the exemplary preform 1 and the exemplary workpiece 200 of FIGS. 2-7 may vary depending on the requirements placed on the fiber composite component, such as the frame 100 or 300, and in particular the positions and arrangement of the recesses 36, 36′ along the arc 3 may be modified. For the recesses 36 in FIG. 6, what has been said above for FIGS. 1 and 9 applies analogously. A web 201, an inner flange 202 and an outer flange 203 are also shown for the workpiece 200 in FIG. 6.

FIG. 2 shows a fiber layer of a planar fiber layer arrangement 6 of the fiber composite plastic preform 1, which is essentially planar as a whole, for the production of a fiber composite component of an arc-shaped design, such as the frame 100 or 300, in the specific case of the exemplary workpiece 200. The fiber layer arrangement 6 substantially follows an arc 3 having a convex outer side 10 and a concave inner side 11. With respect to the curvature of the arc 3, the preform 1 has an outer edge 15 on the outside and an inner edge 16 on the inside.

To form the fiber layer arrangement 6, pre-impregnated fiber material in the form of fiber tapes, formed with continuous reinforcing fibers, is automatically deposited in layers or strata in a so-called AFP process on a layup surface 78 of a laying tool or table provided for this purpose with a body 77 forming the layup surface 78. The fiber tapes are deposited in layers by a computer-controlled depositing device, for example a depositing robot, in such a way that fiber layers with the desired arrangement and orientation of the continuous reinforcing fibers are formed in the desired sequence in the fiber layer arrangement 6. The depositing is performed according to the specification of the fiber composite component 100, 200 or 300 in order to achieve a fiber sequence that allows to meet the requirements of the fiber composite component 100, 200, 300 in terms of mechanical properties and weight, etc.

When laying down the fiber ribbons to build up the preform 1, the planar fiber layer arrangement 6 can be built up locally with different numbers of fiber layers, resulting in the fiber composite component 100, 200, 300 having locally different material thicknesses. For example, the ends 110 in FIG. 1 could be formed thinner than the center 109. A constant thickness and thus constant number of fiber layers throughout the fiber layer assembly 6 is also conceivable.

The reinforcing fibers, which are pre-impregnated in the fiber tapes provided as pre-preg with a preferably thermosetting resin to form a thermoset plastic matrix, can be carbon fibers or glass fibers or other suitable fibers, for example, although combinations of different fiber types are also conceivable in principle.

In one embodiment, it is also possible to use fiber tapes for depositing the preform 1 which have reinforcing fibers of, for example, one or more of the above types pre-impregnated with a thermoplastic resin material to form the matrix.

In FIG. 2, a fiber layer is shown in plan view, within which the fibers run as continuous or endless fibers in 0-degree orientation, i.e. the fibers run along the direction of the arc 3, in other words follow the arc 3 or a direction parallel to the arc 3.

FIG. 3 shows an example of a fiber layer of the preform 1 with 45-degree orientation of the fibers for clarification.

In the embodiment example shown, the fiber layer arrangement 6 may include fiber layers with different fiber orientations in different combinations and sequences, in particular the fiber layers with 0-degree orientation of the fibers as in FIG. 2 and/or the fiber layers with 45-degree orientation of the fibers as in FIG. 3 and/or layers with 90-degree orientation of the fibers and/or layers with 30-degree orientation of the fibers and/or layers in which the fibers are oriented in still other ways. The angular fiber orientation is considered in each case with respect to the direction of the arc 3.

During the formation of the preform 1, the outer edge 15 is formed with gaps 21 which extend into the planar fiber layer arrangement 6. Reference symbol 22 denotes the contour produced in the area of the outer edge 15 for the fiber layer illustrated in the figures, whereas reference symbol 25 denotes the target contour of the preform 1 shown in dashed lines in FIG. 7 for clarification.

The contour 22 is formed in the region of each of the gaps 21 in this case in such a way that the contour 22 runs, at least in sections, in FIGS. 2, 7 exemplarily for a large part of the gap 21 extending with a tongue-like shape into the fiber layer arrangement 6, close to a target contour 45 of a recess 36 or 36′ to be formed in the fiber composite component 100, 200 or 300. This target contour of recess 36 is indicated by reference numeral 28 for preform 1, for example, in the enlargement of FIG. 7, which shows a detail in the vicinity of the leftmost gap 21 in FIG. 2. FIG. 7 illustrates the formation of the fiber composite plastic preform 1 close to the component contour.

FIG. 2 shows that the planar fiber layer arrangement 6 has a first region 55, a second region 56, and a third region 57. The first region 55 is delimited on the concave outer side 10 of the arc 3 by the outer edge 15. On the inner side, i.e. facing away from the outer side 10, the second region 56 adjoins the first region 55. Further on the inside, i.e. again facing away from the outer side 10, the third area 57 adjoins the second area 56. Thus, the inner edge 16 delimits the third region 57 on the concave inner side 11. The first, second and third regions 55, 56, 57 each extend in a strip-like manner along the direction of the arc 3. In this regard, an imaginary line 61 which is substantially arcuate in the embodiment example shown illustrates the boundary between the first and second regions 55, 56, while an imaginary line 62 which is also curved in this embodiment example illustrates the boundary between the second and third regions 56, 57.

In the area 55, which will later—as will be described in detail below—form the outer flange 103, 203 of the fiber composite component 100, 200 or 300, the preform 1 is thus deposited close to the component, as described above. Already before forming, all essential geometric features of the outer flange 103, 203 are applied in the area 55, in particular the recesses 36, 36′ and here again in particular the “mouseholes” 36. The preform 1 can thus be described as a preform 1 that is true to the component contour.

FIG. 7 illustrates that the contour 22 is formed in such a way that the preform 1 has a projection 29 relative to the target contour 28. The protrusion 29 makes it possible to remove material by mechanical processing, such as milling, in a later process step, after a forming of the preform 1 to be explained and a subsequent curing step, in order to achieve the exact, desired target contour 28 in the finished fiber composite component 100, 200, 300 as the target contour 45. Thus, the contour 28 can also be considered as the milling line after curing, shown in the preform 1.

The gaps 21 are already taken into account during the construction of the preform 1 by automated depositing of the fiber tapes, i.e. the individual fiber tapes are deposited, and their length cut in such a way that the edge of the deposited fiber tape arrangement forms the contour 22. In the example shown, the contour 22 is not exactly smooth due to a straight cut of the ends of the fiber tapes to the respective required length, but approximates a smooth contour 22 near the target contour 28. In this way, there is little waste. Subsequent incorporation of the contour 22 in the region of the gaps 21 in a full-surface fiber arrangement, for example by cutting into it before forming the preform 1, can thus be avoided.

FIGS. 2 and 7, for example, also show that a minimum depositing length of the fiber tapes, which may be conditioned on the device side, can lead to protrusions 30 of the actually deposited contour 22 over the target contour 25 of the preform 1 in the area of the outer edge 15, which can be removed subsequently and, for example, together with the protrusion 29. This can be the case namely in areas of the preform 1 in which the deposited tapes are relatively short with the given fiber orientation. Preferably, a course of the contour 22 as close as possible to the target contour 25 of the preform 1 with only slight protrusions 30 is aimed for by optimization. In case of the fiber layer shown as an example in FIG. 3, protrusions 31 result during the depositing process instead of the protrusions 30 shown in FIGS. 2 and 7.

In FIG. 2, the gaps 21 are machined into the preform 1 in areas at irregular distances from one another. In an area of the preform 1 on the left side in FIG. 2, the distance between the gaps 21, taken from the center to the center of the gap 21, is exemplarily d1, while two gaps 21 in FIG. 2 on the right side have a greater distance d2 from each other. The choice of arrangement of the gaps 21 is here component-specific and chosen in such a way that the gaps 21 can form suitable precursors for the recesses 36 desired in the fiber composite component 100, 200, 300. An area-wise or also overall regular spacing of the gaps 21 is also conceivable and can be useful, in particular if the recesses 36 are later to serve, for example, as “mouseholes”. Such a regular spacing of recesses 36 is shown, for example, in FIG. 9 for the fiber composite component 300.

The gaps 21 extend in the preform 1 through the first region 55 and in sections into the second region 56, whereby a part of the recess 36 is later present in the web 101, 201, see FIGS. 2 and 7. In the region of a base 23 of the gap 21, which in the shown embodiment example is directed towards the inner side 11 of the arc 3, the contour 22 approximates the contour of a rounded target contour 25 of the preform 1. Thus, in the region of its base 23, the gap 21 has a substantially rounded-out boundary which runs close to the contour 28, 45 of the likewise rounded-out base 46 of the recess 36 in the fiber composite component 100, 200, 300.

At the outer edge 15, the preform 1 also has rear offsets 66a, 66b in accordance with its target contour 25 indicated by dashed lines, which do not extend into the second region 56. In this way, protruding flap type sections 104, 204 can be formed in the outer flange 103, 203 of the finished fiber composite component 100, 200, 300, for example, at the edge thereof, see also FIGS. 1 and 6. In FIGS. 2 and 7, the precursors of the flap type section 104 and 204, respectively, are designated by the reference sign 68.

The layup surface 78, see FIGS. 4 and 5, has an area on which the layup surface 78 is formed with a sequence of depressions 79 and elevations 81 relative to a base surface 80. The depressions 79 and elevations 81 follow one another along the arc 3 in, for example, a regular sequence.

During the formation of the planar fiber layer arrangement 6, the fiber tapes in the third region 57, or the portions of the fiber tapes respectively to be located in the third region 57, are deposited on the partial area of the layup surface 78 provided with the depressions 79 and elevations 81, whereby the deposited fiber layer arrangement 6 in the third region 57 acquires a wave-like, three-dimensional structure and additional area is provided in the third region 57.

The layup surface 78 is shown in detail in the area provided with the depressions 79 and elevations 81 in a section A-A along an arc section in FIG. 5. In this case, the base surface 80 can, for example, continue continuously into a part 85 of the layup surface 78, i.e. the depressions 79 or elevations 81 are in this case recessed or protruding relative to the layup surface 78 in the part 85. In section A-A, the wave-like surface shape of the layup surface 78 corresponds to a sine wave, although it is understood from FIG. 4 that, for example, in other sections parallel to section A-A and, for example, located further toward the part 85, the wave shape changes as the depressions 79 become narrower and less deep in the direction away from the inner side 11 of the arc 3. In this sense, FIG. 5 represents a kind of middle section through the wave-like shaped area of the layup surface 78. Other wave shapes in the central section are also conceivable in variations. It is further understood that FIG. 4 shows primarily those portions of the layup surface 78 on which fiber tapes come to rest during laying and the fiber layer arrangement 6 of FIGS. 2, 3 is formed. However, the layup surface 78 can expediently also still project beyond the edge of the fiber layer arrangement 6, e.g. for the formation of even larger preforms. The depressions 79 and/or elevations 81 can also extend beyond the part of the layup surface 78 shown in FIG. 4.

Unlike the area assigned to the third region 57, the layup surface 78 does not have depressions or elevations in the further portion 85, but is substantially planar or only slightly curved within the portion 85 compared to the aforementioned depressions 79 and elevations 81. The first region 55 and the second region 56 are formed by depositing the fiber tapes on the portion 85 of the layup surface 78, and are thus formed to be substantially planar or only slightly curved corresponding to said portion 85 of the layup surface 78.

After completion of the preform 1, it is subjected to a hot forming process. For this purpose, the preform 1 can first be removed from the forming surface 78.

Hot forming can be performed by a forming tool not shown in detail in the figures. This forming tool can, for example, have a surface for placing the second area 56 and curved longitudinal surfaces for nestling the first and third areas 55, 57 against these curved surfaces.

During the reshaping of the preform 1, the second area 56 remains substantially without deformation in this example. In particular, the second region 56 remains planar or only slightly curved. However, the second region 56 could also be provided with a slight curvature in the forming step starting from a planar deposited shape thereof.

During the reshaping, the first region 55 is bent or angled relative to the second region 56 upwardly or downwardly out of the drawing plane of FIG. 2 along the arcuate line 61 such that the first region 55 forms the outer flange 103 or 203 of the fiber composite component 100 or 200 or 300, respectively, after curing and material-removing trimming to be described.

During the reshaping, the third region 57 is bent or angled relative to the second region 56, by way of example, to the same side as the first region 55, i.e., upwardly in FIG. 2 or instead downwardly out of the drawing plane, along the arcuate line 62. This is done in such a way that, after curing and material-removing processing, the third region 57 forms the inner flange 102 or 202 of the fiber composite component 100 or 200 or 300.

The web 101 or 201 of the fiber composite component 100, 200 or 300 is formed by the central, second region 56 after curing and trimming.

During this reshaping, the gaps 21 compensate for the excess surface area in the first area 55 compared to its essentially planar shape before the forming process. The gaps 21 absorb the changes in length in the direction of the arc 3, but without closing. The gaps 21 of the preform 1 merge into recesses of the formed preform 1 and remain open as precursors of the recesses 36, 36′.

Thus, while the central, second area 56 “remains in place” during hot forming or at most undergoes a slight curvature and later forms the planar web 101 or 201 according to the final geometry, the first area 55 later forms the curved outer flange 103 or 203, the length being compensated during forming with the aid of the gaps 21.

In addition, when the third region 57 is angled or bent to form the arcuately curved inner flange 102, 202, the wave-like structure in the third region 57 described further above provides the surface area necessary to easily accomplish the forming without damage or unwanted alteration to the fiber assembly.

The formed preform, which is not shown in further detail, can be cured in a suitable curing tool, which is also not shown in further detail, under the effect of increased pressure and increased temperature, in particular after application of a vacuum film and for example in an autoclave. A temperature of 180° C., for example, can be used to cure the matrix material and form the thermoset matrix.

In this regard, the curing tool may, for example, be adapted to the shape of the gaps 21 formed in order to hold the material forming the matrix in place during the curing process. For example, an insertable core could be provided which has a negative structure corresponding to the arrangement of the gaps 21 and generally to the shape of the outer edge 15.

Once the curing is complete, the workpiece is demolded, i.e. the vacuum bag is removed, and the workpiece is taken out of the curing mold. The workpiece is then machined to remove material. During this machining, the precise target contour 45, shown in FIG. 2 by the line 28 for the state of the preform 1, is obtained by milling. After the gaps 21 have already been formed in the preform 1 close to the component contour, only a little material is removed in the material-removing finishing step by milling to achieve the final geometry. This results in little waste material and little scrap. The reduced material usage results in reduced costs in an economically favorable manner. Thus, the recesses 36 do not have to be subsequently machined in their entirety, but their precursors formed by the gaps 21 merely undergo a type of trimming after curing to present the exact target geometry. The trimming can be carried out along the entire outer and inner edges 15, 16 as well as the end edges of the workpiece.

After milling, the dimensional accuracy and freedom from defects of the resulting fiber composite component 100, 200 or 300 are preferably checked, the edges of the fiber composite component 100, 200, 300 are sealed, and the fiber composite component 100, 200, 300 is subjected to a final quality control.

In case of a fiber composite component such as the integral frame 100, which may have a length of several meters, for example between 4 and 5 m, or the integral frame 300 with an exemplary length of between 3 and 4 m, high contour accuracy is often desired. However, during the milling process described above, residual stresses present in the material can be released in the cured workpiece, leading to deformation of the workpiece and thus to deviations from the nominal contour. In addition, shrinkage in the workpiece can occur during the previous curing of the matrix material due to the crosslinking of the same. Both the shrinkage of the matrix and the release of residual stresses lead to changes in geometry in the fiber composite component 100, 200, 300 ultimately obtained and, in combination with each other, to deviations from its nominal geometry.

In an advantageous variant of the procedure for producing a fiber composite component, such as the integral frame 100 or 300, explained above according to an embodiment example, the forming of the preform 1 and the curing of the formed preform are carried out by a forming tool and a curing tool provided separately from the forming tool, wherein the geometry of the curing tool, preferably also of the forming tool, comprises a deformation relative to the nominal geometry of the finished fiber composite component, which “retains” the deformation due to the residual stresses and shrinkage and, in particular, the so-called “spring-in” behavior of the workpiece. This means that the geometry of the forming and/or curing tool deviates from the exact target geometry of the fiber composite component 100, 200, 300, in such a way that the workpiece emerging from the formed preform after curing and before the milling process has a geometry that deviates specifically from the target geometry of the fiber composite component 100, 200, 300. This deviation is selected such that the geometry of the workpiece after milling corresponds as closely as possible to the predefined target geometry. Due to the release of residual stresses in the workpiece during the milling process, deformation of the workpiece occurs. By the targeted maintenance of this geometry change described above, it is possible to achieve that the fiber composite component 100, 200, 300 corresponds even more precisely to the predefined target geometry after milling.

FIG. 8 illustrates the preservation of the deformation of, for example, the fiber composite component 100, 200, or 300 that would be present without this preservation after the completion of the milling process. The deformations or shape deviations are exaggerated in FIG. 8 for clarity. As explained, these shape deviations may be due to the aforementioned release of residual stresses, to resin shrinkage, or to both effects in combination.

With 91, a geometry of an optimized curing tool is shown as an example. The nominal or target geometry of the fiber composite component 100, 200, 300 is shown as 92. The compensated shape deviation of the part with the nominal geometry 92 after milling is shown as 93. Reference characters 94a-e denote different types of deformation that make up the deviation from the target geometry denoted by 93, for example, thrust 94a, expansion 94b, torsion 94c, bending 94d, and “spring-in” 94e.

The shrinkage behavior of the thermosetting resin explained above may contribute to the deformations 94a-e, as mentioned. Resin shrinkage in the region of the joint radius of the outer or inner flange and web (not specified in FIG. 8) contributes to the “spring-in” 94e. Further contributions by shrinkage go in particular into a change 94b in the longitudinal direction of the component 100, 200, 300, into a bending 94d, and, in particular in case of differently dimensioned inner and outer flanges, into a torsion 94c.

With the help of the tool geometry 91 of the curing tool, which differs from 92, the deformation is anticipated and compensated for according to FIG. 8. For example, for this purpose, the web 101, 201 could be slightly curved after curing but before milling, as indicated by geometry 91. Also, see FIG. 8, the outer and inner flanges in geometry 91 could be tilted slightly “outward”, away from the inner portion of the profile, to compensate for the “spring-in” 94e.

Exemplarily, the geometry deviation of the finished fiber composite component 100, 200, 300 from the target geometry may be considered and held in the curing tool alone. Alternatively, additional consideration and “holding in reserve” may be made in the design of the geometry of the forming tool.

Preferably, however, the expected geometry deviation of the finished fiber composite component 100, 200, 300 from the target geometry 92 as explained above is already taken into account and “held” during the forming of the preform 1 and its forming and its curing.

For example, a lay-up tool with the lay-up surface 78 and the lay-up tool body 77, a forming tool provided separately from the lay-up tool, and a curing tool again provided separately from the forming tool are used in the present case for forming and preparing the preform 1 and producing the fiber composite component 100, 200 or 300. However, integration of the forming tool into the curing process, for example as part of the curing tool, is also conceivable in one variant.

In a preferred approach for preserving the geometry changes due to residual stresses and resin shrinkage, the shape deviations are already taken into account in the design of the lay-up tool and thus in the formation of the preform 1, but also in the geometric design of the forming and curing tools in each case.

Accordingly, for example, the base surface 80 of the layup surface 78 can already be formed in a complex manner, for example by introducing a curvature and/or a bend along the arc 3, for example as a global radius, and/or a twist about the direction of the arc 3. However, as explained, the curvature and/or bend and/or twist and/or the global radius for maintaining the deformation 93 can also be introduced only during the forming or curing of the preform 1, the tools used being designed accordingly.

The above has described the manufacture of fiber composite components 100, 200, 300 in which reinforcing fibers are embedded in a thermoset plastic matrix, the matrix being formed by curing a resin. As mentioned above, a thermoplastic plastic material may also be considered for the matrix. In this case, the matrix is not cured, but may be subjected to an elevated temperature, e.g., exceeding the glass transition temperature of the thermoplastic matrix, after hot working to fix the final shape.

Although the invention has been fully described above with reference to examples of embodiments, it is not limited thereto, but can be modified in a variety of ways.

In particular, the invention is not limited to ribs for fuselage shells as fiber composite components. The invention can also be useful and find application in the manufacture of other profile-shaped and curved fiber composite parts.

### LIST OF REFERENCE SIGNS

1 preform

3 arc

6 fiber layer arrangement

10 outside

11 inside

12 outer edge

16 inner edge

21 gap

22 contour (preform)

23 base

25 target contour (preform)

28 target contour (fiber composite component; shown in preform)

29 projection

30 projection

31 projection

36, 36′ recess

45 target contour

46 base

55 first area

56 second area

57 third area

61 line

62 line

66a, 66b rear offset

68 precursor for flap type section

77 laying tool body

78 layup surface

79 gap (layup surface)

80 base area (layup surface)

81 elevation (layup surface)

85 part (layup surface)

91 curing tool geometry

92 target geometry of the fiber composite component

93 compensated deformation of the fiber composite component

94a-e deformations

100 integral frame

101 web

102 inner flange

103 outer flange

104 flap type section

109 center

110 front end

200 fiber composite component

201 web

202 inner flange

203 outer flange

204 flap type section

300 integral frame

d1, d2 distance

h height (web)

1. A method of manufacturing an arc-shaped fiber composite component, comprising:
forming a preform with a planar fiber layer arrangement formed along an arc, having an outer edge assigned to a convex outer side of the arc, wherein the outer edge is formed with gaps extending into the planar fiber layer arrangement in such a way that a contour of the gaps is formed in each case at least in parts close to a target contour of a recess to be provided in the fiber composite component, at least in sections except for a projection which, after further processing of the preform in a later step, enables material-removing processing for precisely achieving the target contour; and
reshaping the preform in such a way that at least a first region of the planar fiber layer arrangement, which adjoins the outer edge, extends essentially in the direction of the arc, is bent or angled relative to a second region of the planar fiber layer arrangement adjoining the first region and facing away from the outer side of the arc, wherein, during the formation of the formed preform, the gaps, which the preform has before reshaping, merge into recesses of the formed preform and remain open.

2. The method according to claim 1, wherein the gaps extend through the first region of the planar fiber layer arrangement and further extend in sections into the second region of the planar fiber layer arrangement.

3. The method according to claim 1, wherein the gaps are arranged along the arc in at least regionally irregular intervals.

4. The method according to claim 1, wherein the recess in the fiber composite component according to the target contour thereof each has a rounded-out base.

5. The method according to claim 1, wherein the outer edge is additionally formed with at least one rear offset extending into the planar fiber layer arrangement and ending before reaching the second region.

6. The method according to claim 1, wherein during forming the preform, the fiber layer arrangement is formed on a layup surface having an area with a succession of depressions and/or elevations relative to a base area of the layup surface following one another in the direction of the arc, wherein the planar fiber layer arrangement is formed with an inner edge assigned to a concave inner side of the arc, and a third region of the planar fiber layer arrangement, which extends adjacent to the inner edge substantially in the direction of the arc, is formed at least partially on the region of the layup surface provided with the depressions and/or elevations.

7. The method according to claim 1, wherein the first region and the second region of the planar fiber layer arrangement of the preform are formed prior to the forming of the preform on a substantially planar or only slightly curved surface part, compared to the region of the layup surface provided with the depressions and/or elevations.

8. The method according to claim 1, wherein the fiber composite component is formed in a profiled shape with an outer flange, an inner flange and a web connected to the outer flange and the inner flange between the outer flange and the inner flange, wherein the outer flange is formed with the first area of the planar fiber layer assembly, the web is formed with the second area of the planar fiber layer assembly, and the inner flange is formed with the third area of the planar fiber layer assembly.

9. The method according to claim 1, wherein the planar fiber layer arrangement is formed by automated laying down of fiber tapes.

10. The method according to claim 1, wherein the fiber layer assembly is formed with reinforcing fibers pre-impregnated with a matrix material.

11. The method according to claim 1 wherein
the forming and/or reshaping of the preform and/or the further processing thereof are carried out in such a way that the, cured, workpiece which emerges from the reshaped preform has, before material-removing processing thereof, a geometry which deviates in a targeted manner from the target geometry of the fiber composite component in such a way that the geometry of the workpiece after the material-removing processing essentially corresponds to the target geometry; and/or
the forming of preform takes place on a layup surface, the reshaping of the preform takes place by a shaping tool and a further processing of the shaped, cured, preform takes place by a further processing tool, wherein a shaping of the layup surface and/or of a base surface thereof and/or of the shaping tool and/or of the further processing tool deviates specifically from the target geometry of the fiber composite component to take into account shape deviations during further processing and shape deviations during material-removing processing, such that the finished fiber composite component essentially corresponds to the target geometry.

12. The method according to claim 1, wherein the fiber composite component is formed as a frame or a section of a frame for an aircraft or spacecraft.

13. The method according to claim 1, wherein at least one or more or all of the recesses in the fiber composite component is/are each provided as a passageway for the passage of at least one stringer.

14. The method according to claim 1, wherein at least one or more or all of the recesses in the fiber composite component is/are formed with a mousehole-like shape.

15. A preform for the manufacture of an arc-shaped fiber composite component by a process according to claim 1, with forming of the preform, with a planar fiber layer arrangement formed along an arc with an outer edge assigned to a convex outer side of the arc, which is formed with gaps extending into the planar fiber layer arrangement, a contour of the gaps in each case being close, at least in sections, to a target contour of a fiber composite component to be produced, in particular at least in sections as far as a projection which, after further processing of the preform in a later step, enables material-removing processing for precisely reaching the target contour.
